(19) United States
(12) Patent Application Publication
(10) Pub. No.: US 2026/0331361 A1
(43) Pub. Date: Oct. 22, 2026

(54) Preformed Coil Support Apparatus

(71) Applicant: ABB Schweiz AG, Baden (CH)

(72) Inventors: Brian J. Baldwin, Summit, WI (US); Kalyan P. Gokhale, New Berlin, WI (US)

(73) Assignee: ABB Schweiz AG, Baden (CH)

(21) Appl. No.: 19/180,360

(22) Filed: Apr. 16, 2025

(51) Int. Cl. H01F 27/30; H01F 27/24; H01F 27/32

(52) U.S. Cl. CPC H01F 27/306; H01F 27/24; H01F 27/324

(57) ABSTRACT

A preformed, bobbin-less coil assembly device including a core with a first side, a preformed coil having a plurality of turns, a first insulator positioned in a clearance space between a radial inner surface of the first radial side of the plurality of preformed coils and the core, and a mounting clamp. The mounting clamp includes a clamp band, a clamp spring, and a first end of the mounting clamp.

### FIELD

The present disclosure relates to a preformed coil support apparatus for an electromagnetic device.

### BACKGROUND

In electromagnetic machinery such as motors, transformers, and inductors, it is prudent to ensure proper alignment and support of coils in relation to the core structure to maintain operational efficiency and reliability.

In such devices, the core typically consists of one or more legs, which provide structural support and magnetic flux guidance for the coils wound around them. However, due to variations in coil geometries and the diversity of leg core configurations, designing a support system typically demands a specific design for each configuration. Pre-formed coils are often produced in standardized shapes and sizes, while yoke cores may have varying leg lengths, angles, cross-sectional shapes, and magnetic characteristics. This discrepancy in dimensionality complicates the process of properly affixing coils to the core, leading to potential misalignments, mechanical stresses, inefficiencies in electromagnetic performance, and/or added costs associated with a number varieties of coils, yoke cores, and supports therebetween.

Coils should be securely and stably positioned around the stacks of leg cores, to prevent destructive vibrations or other instabilities, typically precluding configurations where the coil and the leg core features differ moderately or significantly in size, curvature, or geometry. For example, a single yoke core design may only typically be compatible with a single preformed coil design. Moreover, a coil designed for a rectangular leg may not properly mate with a more rounded or tapering leg, resulting in poor performance, excessive vibrations/wear, or even failure of the system. Moreover, in the case of large-scale or custom applications, it can be costly to redesign coils or yoke cores to match one another precisely, to utilize a traditional inflexible support system that does not consider accommodating a wide range of geometrical variations.

### SUMMARY

An embodiment of the present disclosure provides a preformed, bobbin-less coil assembly device, the coil assembly device comprising a core with a first side, a preformed coil having a plurality of turns, the preformed coil configured to sleeve over the core in an axial direction, having a clearance space between the preformed coil and the core in directions radial to the axial direction, the preformed coil having a first radial side with a radial inner surface and a radial outer surface, a first insulator positioned in the clearance space and between the radial inner surface of the first radial side of the plurality of preformed coils and the core, a mounting clamp comprising a clamp band, a clamp spring, and a first end of the mounting clamp, wherein the clamp band straddles a portion of the radial outer surface of the first radial side of the preformed coil along the axial direction, wherein the first end of the mounting clamp is affixed to the core such that the clamp spring is deflected, and an insulating sheet disposed between the clamp band and the radial outer surface of the first radial side of the preformed coil, wherein the deflection of the clamp spring by the core urges the clamp band toward the core, and thereby the first radial side of the preformed coil is bracketed to the core.

In an embodiment of the preformed, bobbin-less coil assembly device, a second radial side of the preformed coil is opposite the first radial side of the preformed coil, and the second radial side of the preformed coil is a floating side unbracketed to the core.

In an embodiment of the preformed, bobbin-less coil assembly device, a first core support is arranged between the first side of the core and the first insulator, affixed to the core.

In an embodiment of the preformed, bobbin-less coil assembly device, further comprises a first spring damper positioned in the clearance space and between a radial inner surface of the second radial side of the preformed coil and the leg core or a second core support along a second side of the core, the second side of the core corresponding to the second radial side of the preformed coil wherein the first spring damper is positioned in a locking depression of the core or the second core support, and wherein the first spring damper is configured to dampen the radial vibrations of the core or the preformed coil which affect the size of the clearance space.

In an embodiment of the preformed, bobbin-less coil assembly device, the first insulator is positioned on a first end of the first radial side of the preformed coil, further comprising a second insulator positioned in the clearance space and between a second end of the radial inner surface of the first radial side of the preformed coil and the core.

In an embodiment of the preformed, bobbin-less coil assembly device, further comprises a third radial side and a fourth radial side of the preformed coil, the third radial side and fourth radial side being at 90 degrees to the first radial side as well as floating sides unbracketed to the core.

In an embodiment of the preformed, bobbin-less coil assembly device, the first core support end and the first end of the mounting clamp are affixed to the yoke core at a same position, such that the clamp spring is deflected and the first core support is undeflected or deflected to a lesser or insubstantial degree relative to the deflection of the clamp spring.

In an embodiment of the preformed, bobbin-less coil assembly device, the mounting clamp further comprises: a clamp rib disposed between the clamp spring and the first end of the mounting clamp and configured to mitigate deflection of the mounting clamp proximate to the clamp rib, and mounting clamp hems along both of two edges of the clamp band, the edges extending along the clamp band in the axial direction.

An exemplary embodiment of the present disclosure provides a preformed, bobbin-less coil assembly device, the coil assembly device comprising: a yoke core or external support, a leg core of the yoke core with a first side, a first core support along the first side of the leg core, affixed to the leg core of the yoke core and the yoke core or external support, a preformed coil assembly configured to sleeve over the leg core in an axial direction with clearance space in radial directions, the preformed coil assembly including: a first radial side, a plurality of nested preformed coils having at least one nested clearance space and an at least one nested insulating sheet on the first radial side between each of the plurality of nested coils, a radial inner surface of the first radial side of an innermost coil of the preformed coil assembly, and a radial outer surface of the first radial side of an outermost coil of the preformed coil assembly, wherein the plurality of preformed coils are concentric to one another, a first insulator positioned in the clearance space and between the radial inner surface of the first radial side of the preformed coil assembly and the leg core, a mounting clamp comprising: a clamp band, a clamp spring, and a first end of the mounting clamp, wherein the clamp band straddles the radial outer surface of the first radial side of the preformed coil assembly along the axial direction, wherein the first end of the mounting clamp is affixed to the yoke core or external support such that the clamp spring is deflected, and a first insulating sheet disposed between the clamp band and the radial outer surface of the first side of the preformed coil assembly, wherein the radial directions are radial to the axial direction, wherein the deflection of the clamp spring by the yoke core or external support urges the clamp band toward the radial outer surface, whereby the first insulating sheet is compressed and the radial outer surface is urged toward the radial inner surface, whereby each of the plurality of nested preformed coils are compressed upon each of the at least one nested insulating sheets and the radial inner surface is urged toward the leg core of the yoke core, whereby the first insulator is compressed to dampen radial vibrations of the leg core or preformed coil assembly which affect a size of the clearance space, and thereby the first radial side of the preformed coil assembly are bracketed to the core yoke or the external support.

In an embodiment of the preformed, bobbin-less coil assembly device, a second radial side of the preformed coil assembly is opposite the first radial side of the preformed coil assembly, and the second radial side of the preformed coil assembly is a floating side unbracketed to the yoke core or the external support.

In an embodiment of the preformed, bobbin-less coil assembly device, the first core support is disposed between the first insulator and the leg core.

In an embodiment of the preformed, bobbin-less coil assembly device, further comprises a first spring damper positioned in the clearance space and between a second radial inner surface, the second radial inner surface being of the innermost coil of preformed coil assembly and of the second radial side, of the preformed coil assembly and the leg core or a second core support along a second side of the leg core, wherein the first spring damper is positioned in a locking depression of the leg core or the second core support, and wherein the first spring damper is configured to dampen the radial vibrations of the leg core or preformed coil assembly which affect the size of the clearance space.

In an embodiment of the preformed, bobbin-less coil assembly device, the first insulator is positioned on a first end of the first radial side of the preformed coil assembly, further comprising: a second insulator positioned in the clearance space and between a second end of the radial inner surface of the first radial side of the preformed coil assembly and the leg core.

In an embodiment of the preformed, bobbin-less coil assembly device, further comprises a third radial side and a fourth radial side of the preformed coil assembly, the third radial side and fourth radial side being at 90 degrees to the first radial side as well as floating sides unbracketed to the core yoke.

An exemplary embodiment of the present disclosure provides a system of preformed, bobbin-less coil assembly devices, comprising: a yoke core, and a plurality of preformed, bobbin-less coil assembly devices, each device comprising: a leg core of the yoke core with a first side, a first core support along the first side of the leg core, affixed to the leg core of the yoke core and the yoke core, a preformed coil assembly configured to sleeve over the leg core in an axial direction with clearance space in radial directions, the preformed coil assembly including: a first radial side, a plurality of nested preformed coils having at least one nested clearance space and an at least one nested insulating sheet on the first radial side between each of the plurality of nested coils, a radial inner surface of the first radial side of an innermost coil of the preformed coil assembly, and a radial outer surface of the first radial side of an outermost coil of the preformed coil assembly, wherein the plurality of preformed coils are concentric to one another, a first insulator positioned in the clearance space and between the radial inner surface of the first radial side of the preformed coil assembly and the leg core, a mounting clamp comprising: a clamp band, a clamp spring, and a first end of the mounting clamp, wherein the clamp band straddles the radial outer surface of the first radial side of the preformed coil assembly along the axial direction, wherein the first end of the mounting clamp is affixed to the yoke core or such that the clamp spring is deflected, and a first insulating sheet disposed between the clamp band and the radial outer surface of the first side of the preformed coil assembly, wherein the radial directions are radial to the axial direction, wherein the deflection of the clamp spring by the yoke core urges the clamp band toward the radial outer surface, whereby the first insulating sheet is compressed and the radial outer surface is urged toward the radial inner surface, whereby each of the plurality of nested preformed coils are compressed upon each of the at least one nested insulating sheets and the radial inner surface is urged toward the leg core of the yoke core, whereby the first insulator is compressed to dampen radial vibrations of the leg core or preformed coil assembly which affect a size of the clearance space, and thereby the first radial side of the preformed coil assembly are bracketed to the core yoke.

In an embodiment of the system of preformed, bobbin-less coil assembly devices, a second radial side of the preformed coil assembly is opposite the first radial side of the preformed coil assembly, and the second radial side of the preformed coil assembly is a floating side unbracketed to the yoke core.

In an embodiment of the system of preformed, bobbin-less coil assembly devices, the first core support is disposed between the first insulator and the leg core.

In an embodiment of the system of preformed, bobbin-less coil assembly devices, further comprising a first spring damper positioned in the clearance space and between a radial inner surface of the second radial side of the preformed coil assembly and the leg core or a second core support along a second side of the leg core, wherein the first spring damper is positioned in a locking depression of the leg core or the second core support, and wherein the first spring damper is configured to dampen the radial vibrations of the leg core or preformed coil assembly which affect the size of the clearance space.

In an embodiment of the system of preformed, bobbin-less coil assembly devices, the first insulator is positioned on a first end of the first radial side of the preformed coil assembly, further comprising: a second insulator positioned in the clearance space and between a second end of the radial inner surface of the first radial side of the preformed coil assembly and the leg core.

In an embodiment of the system of preformed, bobbin-less coil assembly devices, further comprises a third radial side and a fourth radial side of the preformed coil assembly, the third radial side and fourth radial side being at 90 degrees to the first radial side as well as floating sides unbracketed to the core yoke.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a construction of an inductor such as a typical three-phase inductor including a superset configuration of leg and coil assemblies in assembled states, in accordance with one or more examples of the present disclosure;

FIG. 2 shows a leg and coil assembly including two preformed coils and a leg core with a mounting clamp in an undeflected state, in accordance with one or more examples of the present disclosure;

FIG. 3 shows a side view of an embodiment of a leg and core assembly in an undeflected state, in accordance with one or more examples of the present disclosure;

FIG. 4 shows an embodiment of a clamp band, in accordance with one or more examples of the present disclosure;

FIG. 5 shows an example of an insulating sheet 4 that can be disposed between the mounting clamp 6 and the coil 1, or alternatively between the layers of multiple concentric coils, in accordance with one or more examples of the present disclosure;

FIG. 6 shows an embodiment of a leg and coil assembly with a spring damper inserted between the preformed coil and the leg core on a floating side, in accordance with one or more examples of the present disclosure;

FIG. 7 shows an embodiment of an inductor wherein only one coil is sleeved upon the leg core in the leg and coil assembly, in accordance with one or more examples of the present disclosure;

FIG. 8 shows an embodiment of an inductor in a configuration with three leg and coil assemblies, wherein each assembly comprises only one coil, in accordance with one or more examples of the present disclosure; and

FIG. 9 shows a diagram view of a E+I core with one or more coils 1 on the center leg of E core.

### DETAILED DESCRIPTION

In an embodiment, the present disclosure provides an inductor with loose fit coils clamped on one side of the leg core.

An embodiment of the present disclosure provides a preformed, bobbin-less coil assembly device, the coil assembly device comprising a core with a first side, a preformed coil having a plurality of turns, the preformed coil configured to sleeve over the core in an axial direction, having a clearance space between the preformed coil and the core in directions radial to the axial direction, the preformed coil having a first radial side with a radial inner surface and a radial outer surface, a first insulator positioned in the clearance space and between the radial inner surface of the first radial side of the plurality of preformed coils and the core, a mounting clamp comprising a clamp band, a clamp spring, and a first end of the mounting clamp, wherein the clamp band straddles a portion of the radial outer surface of the first radial side of the preformed coil along the axial direction, wherein the first end of the mounting clamp is affixed to the core such that the clamp spring is deflected, and an insulating sheet disposed between the clamp band and the radial outer surface of the first radial side of the preformed coil, wherein the deflection of the clamp spring by the core urges the clamp band toward the core, and thereby the first radial side of the preformed coil is bracketed to the core.

This present disclosure describes a design to secure a solid conductor wound electrical coil around an inductor's core stack. Conventionally, a coil is wound around a bobbin or a coil former or a mandrel which provides the mechanical support for the coil and then the bobbin plus the coil assembly is placed around the magnetic core. A relatively large cross-sectional area conductor, having a round or rectangular cross section, is difficult to wind around a conventional bobbin or a mandrel. The present disclosure describes method(s) to assemble and mechanically secure a preformed bobbin-less coil around the magnetic core of an inductor. This preformed coil can be prefabricated and sleeved upon the magnetic core, such that it is easily assembled, easily serviced or replaced, and easily manufactured. The spacing between the coils and the other features, such as the magnetic core and/or other coils (where there are multiple coils), further provides better airflow and cooling properties versus the traditional wound coils, wherein the individual turn of the coil or coils smother one another and the magnetic core.

The present disclosure mounts and mechanically secures such a preformed coil around the magnetic core of the inductor. The inside dimensions of the coil is oversized in comparison to the outside dimensions of the magnetic core so that the coil can slide over the core. The coil will be loose fitting over the core and then it will be secured to the core using a clamping force in one direction against the core. It is difficult to clamp in more than one direction because the overall dimensions of the coil can be unpredictable and have large tolerances without the traditional ‘smothered’ winding technique. These changes in dimension stem from both inevitable variations in manufacturing precision of goods, as well as due to changing configurations of cores and coils for such devices.

An embodiment of the present disclosure uses a combination of insulators and a sheet metal mounting clamp with a built-in spring feature to secure the coil to the core after sliding the coil over the core. The design accommodates dimensional variance in the inside dimensions of the coil, without using the bobbins or mandrels.

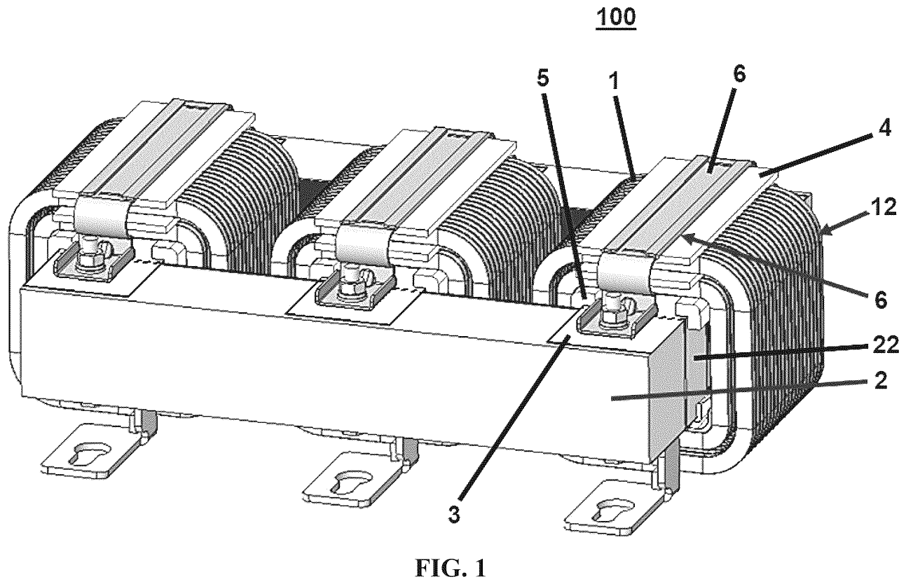

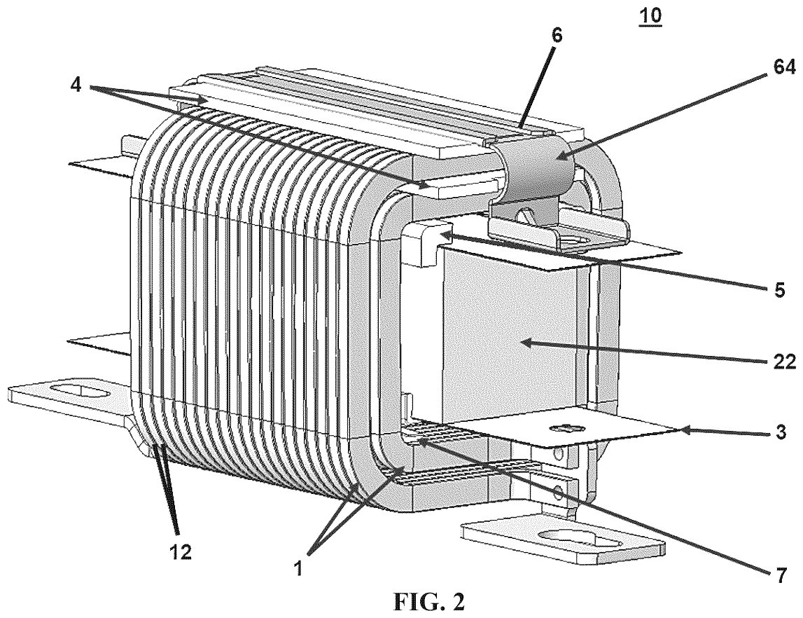

An embodiment provides the construction of an inductor element used in electrical systems. FIG. 1 shows a construction of an inductor 100 such as a typical three-phase inductor, the inductor 100 including a superset configuration of leg and coil assemblies 10 in assembled states including a yoke core 2, preformed coils 1 assembled around a stack of leg cores 22, a yoke core 2, and mounting clamps 6. FIG. 2 shows a subset of a leg and coil assembly 10 including two preformed coils 1 and a leg core 22 with a mounting clamp 6 in a partially assembled state, specifically an undeflected state or an unclamped state. In the undeflected state, the mounting clamp 6 is not connected to the yoke core 2. A core support 3 is arranged on two sides of leg core 22. The undeflected state of the mounting clamp 6 of FIG. 2 leaves a space between an end 612 of the mounting clamp 6 and an upper core support 3, whereas this space is closed in the assembled state of FIG. 1. The preformed coil 1 can be formed of a suitable solid conductor such as Al or Cu, and may itself be coated from dust and liquid debris using a few different methods. The preformed coil 1 may be covered in enamel to protect against dust. Cloth wrapped Nomex wire may be used to further protect the preformed coil 1 from liquids. Epoxy coting the preformed coil 1 after the final forming process can be an alternative coating method to the cloth wrapped Nomex method. In this and other embodiments, multiple concentric coils 1 optimize inductor performance or are necessary to have enough coil turns 12 around the core, series connected or otherwise, to increase the effective cross-sectional area of the conductor 22 (parallel connected). In another embodiment, the inductor 100 can include a single leg core 22. The preformed coils 1 of FIG. 1 include twenty turns 12 of the preformed coil 1 or thereabouts. However, other embodiments with differing numbers of turns 12 are provided. In some embodiments, the preformed coil 1 can be understood as any plurality of coil turns that are not traditionally wound upon or otherwise traditionally self-seating upon a bobbin or the leg core 2.

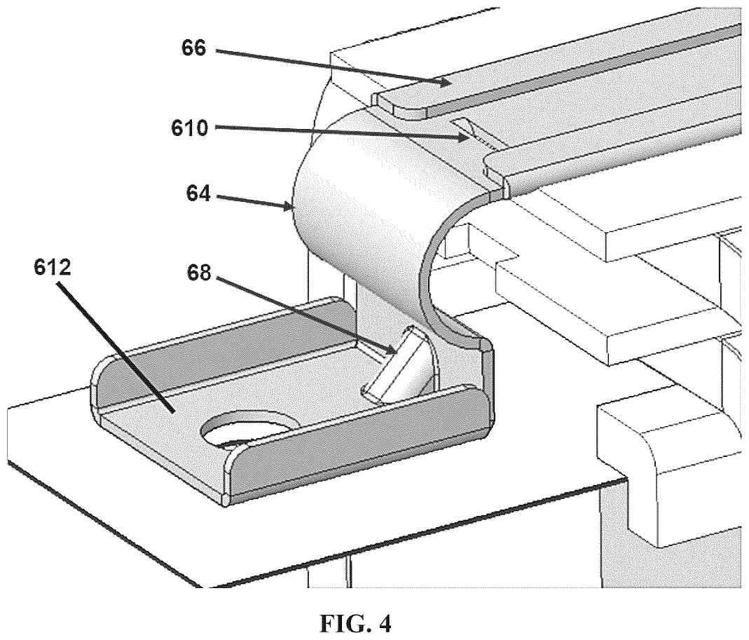

The mounting clamp 6 comprises clamp spring 64. In the deflected state, clamp spring 64 is deflected such that, while the clamp spring 64 does not experience plastic deformation, the mounting clamp 6 is urged toward the remaining features between it and the leg core 22 in a clamping action with a force that creates an interference fit between the mounting clamp 6, and leg core 22, and all the features therebetween. See in further detail with respect to FIG. 4 below. The mounting clamp 6 can be placed in the deflected state during assembly of the leg and core assembly 10 via the fixing of the ends of the mounting clamp 6 to the yoke core 2, which pulls the clamp spring 64 into deflection, which in turn imparts the clamping action and force upon the leg and coil assembly 10.

The mounting clamp 6 of the leg and coil assembly 10 is arranged on one side of the leg core 22. The other side or sides are floating, or loose fitting, with gaps created between the coil 1 and leg core 22, foregoing load-bearing structures across the gaps between the coil 1 and the core leg 22. The floating sides and gaps created by the mounting clamp 6, and the leg and coil assembly 10 as a whole, enable a high degree of flexibility in embodiments of the present disclosure that can accommodate manufacturing irregularities across a single inductor 100 configuration and create compatibility in such embodiments with a wider range of inductor configurations. Moreover, the elimination of load-bearing structures across the gaps of the remaining sides of the leg and coil assembly 10 eliminates the tension formed by counterbalancing rigid support structures urging the coil 1 of the leg and coil assembly 10 in conflicting directions and reduces risks of mechanical fatigue and failure and the need to overengineer support structures.

The inside dimension of the preformed coil 1 is oversized in comparison to the outside dimension of the leg core 22. This allows the coil 1 to slide over the leg core 22 and with sufficient distance to operate effectively. The preformed coil 1 of FIG. 2 loosely aligns with two corner insulators 5 between the preformed coil 1 and the leg core 22 to maintain a suitable electrical clearance between the preformed coil 1 and the leg core 22. This loose alignment both creates tolerance for manufacturing variations in the overall inside and outside dimension of the preformed coil 1 as well as to permits flexibility between specific design configurations of the leg cores 22, coils 1, and leg and core assemblies 10 for various inductors 1. The preformed coil 1 will only be clamped to the leg core 22 on one side. The other side or sides are floating or loose fitting around the leg core 22, to operate as intended while tolerating unpredictability of where the preformed coil 1 surfaces with be on the loose fitting side or sides with respect to the leg core 22.

The clamping of the mounting clamp 6 to the leg and coil assembly 10 such that the leg and coil assembly 10 is secured occurs during assembly. A clamping force will be applied through the mounting clamp 6, though insulating sheets 4, though the leg and coil assembly 10 and corner insulators 5, until the force is applied against the leg core 22 surface.

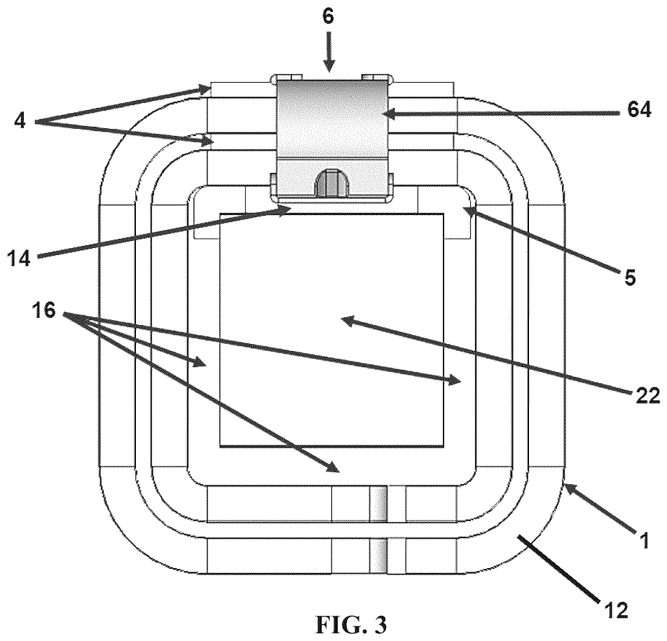

FIG. 3 shows a side view of an embodiment of a leg and core assembly 10 in a partially assembled state, particularly an undeflected state. There is a readily visible space between the mounting clamp 6 and the leg core 22 on the first side 14 due to the undeflected state. The remaining sides are floating sides 16.

FIG. 4 shows an embodiment of a clamp band 62, connected to an end 612 of the mounting clamp 6 by a clamp spring 64. Further embodiments will provide two clamp springs 64 on two ends 612 of the mounting clamp 6.

Further optional embodiments of the mounting clamp 6 are provided, for example, in an embodiment, the portion of the mounting clamp 6 between the clamp spring 64 and the end 612 of the mounting clamp 6, potentially including the end 612 of the mounting clamp 6, is reinforced by a clamp rib 68 or a securing feature that isolates the deflection of the mounting clamp 6 from extending beyond the clamp spring 64. Some embodiments of the clamp band 62 includes a clamp hem 66 on one or both sides of the clamp band 62 in a radial direction such as toward the end 612 of the mounting clamp 6, wherein the clamp hem 66 provides extra stability for the mounting clamp and further isolating the deflection of the mounting clamp 6 from extending beyond the clamp spring 64. An embodiment provides a clamp lance 610 to improve locating and aligning with the insulating sheet 4 to prevent electrical breakdown between the mounting clamp 6 and the coil 1. An example of the electrical breakdown includes the coil 1 being energized to 650 V and arcing to the clamp 6 which is at ground potential. These features are advantageous as described; however, other embodiments of mounting clamp 6 lacking these features are foreseeable. For example, embodiments of the present disclosure can include a mounting clamp 6 absent a clamp rib 68, clamp hem 66, and clamp spring 64.

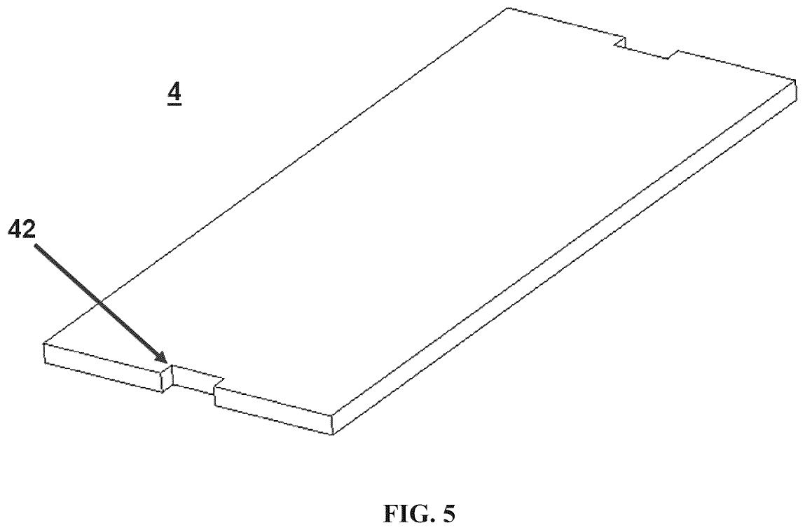

FIG. 5 shows an example of an insulating sheet 4 that can be disposed between the mounting clamp 6 and the coil 1, or alternatively between the layers of multiple concentric coils 1 in a nested example. The insulating sheet 4 serves to provide insulation and maintains an electrical clearance between the mounting clamp 6 and the preformed coil 1. In an embodiment, the insulting sheet 4 includes a locating notch 42 at the end of the insulating sheet, to locate and align the insulating sheet 4 with the mounting clamp 6. This locating notch 42 at the end of the insulating sheet 4 can be a radial end configured to be disposed toward the end 612 of the mounting clamp 6 in an assembled state. Specifically, the locating notch 42 can be aligned with the clamp lance 610 in the assembled state. This insulating sheet 4 provides a bearing surface against the preformed coil 1 that is electrically isolated and will maintain an appropriate electrical clearance and creepage distance between the preformed coil 1 and the mounting clamp 6. The insulating sheet can be made of an appropriate insulating material such as Rynite, a plastic PET, reinforced with 30% glass fiber, or Mylar or Lexan, etc.

In some embodiments, features such as the core support 3, insulating sheet 4, and corner insulator 5 (as well as spring damper 7 described below) are modular and easily produced and stocked for various dimensional configurations of leg and coil assemblies 10, given the cross-over applicability of a small number of such features to different configurations. Moreover, in an embodiment, such features as core support 3, insulating sheet 4, and corner insulator 5 (as well as spring damper 7 described below) can be held constant, while only the mounting clamp 6 is produced and stocked with varying dimensions for different configurations. In a further aspect, only the clamp spring 64 of the mounting clamp 6 is altered. These variations ensure that the clamp spring 64 of the mounting clamp 6 always experiences deflection in a suitable range, such that the clamp spring 64 does not experience plastic deformation yet is deflected greatly enough that the clamp band 62 is urged toward the remaining features between it and the leg core 22 in a clamping action with a force that creates an interference fit between the mounting clamp 6 and the insulating sheet 4, a subsequent interference fit between the insulating sheet 4 and the coil 1, and so on up to and including an ultimate interference fit between the corner insulator 5 and the leg core 22. It is noted that in a nested coil embodiment, the nested layers of coils 1 and the insulating sheets 4 separating them are iteratively placed in interference fits with one another via the same clamping action described immediately above, in a coil assembly.

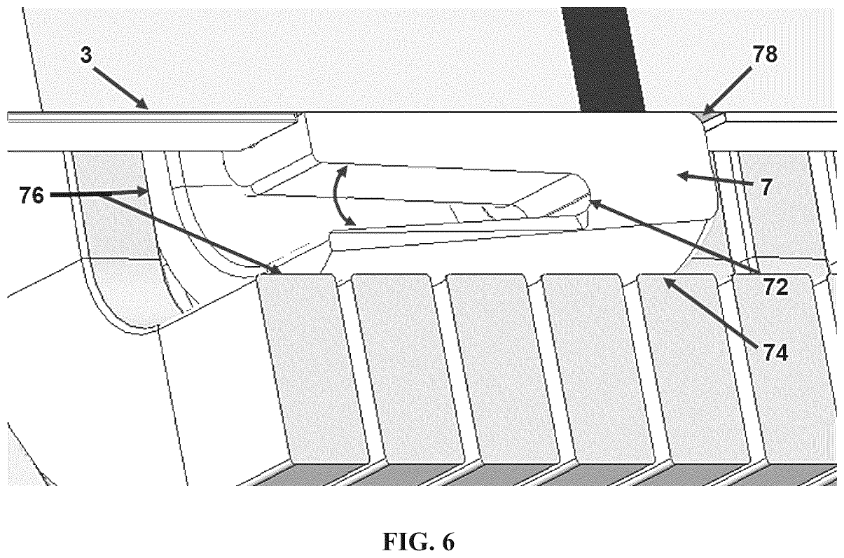

FIG. 6 shows an embodiment of a leg and coil assembly 10 with a spring damper 7 inserted between the preformed coil 1 and the leg core 22 on a floating side or at the apex between two sides. In a preferred embodiment, this spring damper or insulator 7 is non-load-bearing and clips into the leg and core assembly 10 when already in the assembled state. The spring damper 7 has a spring feature 72 designed into the spring damper 7 to allow the insulating surface to support the preformed coil inner dimension and flex to adjust to the tolerance of the preformed coil inner dimension. In an embodiment, the spring damper 7 is built with an interference fit 76 between the spring damper 7 and two floating, sides of the inner diameter 74 of the preformed coil 1, unsupported by the mounting clamp 6. The interference fit 76 will cause the spring feature 72 to flex, causing two ends of the spring damper 7 away from the spring element 72 to cantilever toward one another. Another embodiment of a leg and coil assembly 10 with a spring damper 7 with an interference fit 76 can be between an unsupported side and the supported side. In a preferred embodiment, the spring damper 7 locks into place by sitting into a locking depression such as a locking depression in the leg core 22, or a locking depression 78 in the core support 3, or a similarly configured depression. Once the spring damper 7 is placed into the locking depression, the spring damper 7 will relax its spring element 72 by the amount of the thickness of the locking depression, which prevents it from moving out of place during use and vibration. Spring damper 7 may comprise a soft insulator and/or a similar material to corner insulator 5 or insulating sheet 4. In an embodiment, spring damper 7 can be understood as distinguished from corner insulator 5 or insulating sheet 4 insofar as corner insulator 5 and insulting sheet 4 are load-bearing, where spring damper 7 is not. The corner insulator 5 and the insulating sheet 4 alter the relative positions of the mounting clamp 6, preformed coil 1, and the core in the clamped state. The spring damper 7 does not. Spring damper 7 serves to diminish vibrations during operation. While such an embodiment with spring damper 7 is advantageous, other embodiments without it or any other feature on the floating side(s) are foreseeable.

An embodiment of the leg and coil assembly 10 with the spring damper 7 is advantageous in that it is a manufacturing tolerance flexible clip-in or otherwise easily applied solution to any vibrations of unsupported sides of preformed coils 1 which can threaten to decrease electrical clearances between, for example, a preformed coil 1 and a leg core 22 to an undesirable or dangerous level, or create mechanical stress, damage, fatigue, or breaking of such components. The rigid connection of traditional solutions, or even the flexible design of the present embodiment with respect to the supported side, is costly overkill that is problematic in implementation for all of the reasons described above and in the background. In an embodiment, the dual flexible approaches described herein with respect to both the supported side and the unsupported side(s) provides a particularly advantageous support system for leg and coil assemblies 10 utilizing preformed coils or similarly loose-fit coil designs over the traditional coil wound about a bobbin.

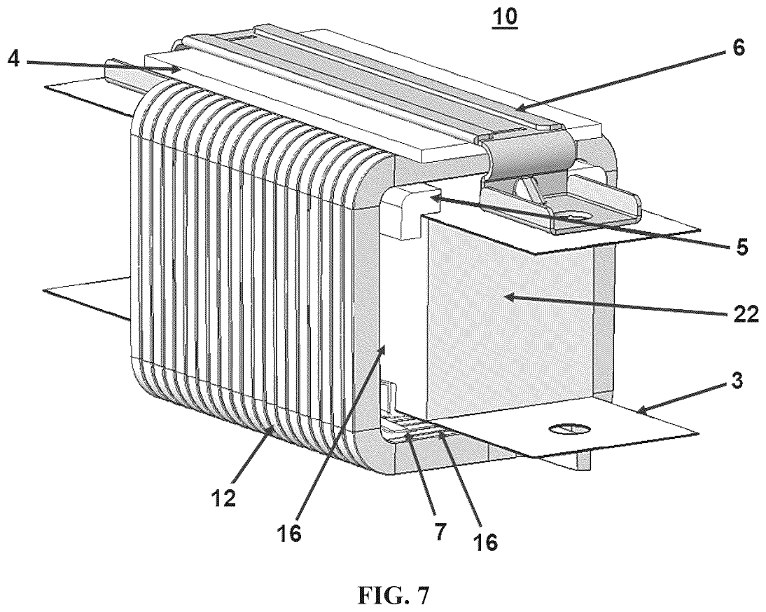

FIG. 7 shows an embodiment of an inductor 1 wherein only one preformed coil 1 is sleeved upon the leg core 22 in the leg and coil assembly 10. An insulating sheet 4 is arranged between the mounting clamp 6 and the preformed coil 1, and a corner insulator 5 is arranged between the preformed coil 1 and the leg core 22. In an embodiment, a spring damper 7 is also arranged between the leg core 22 and the coil 1.

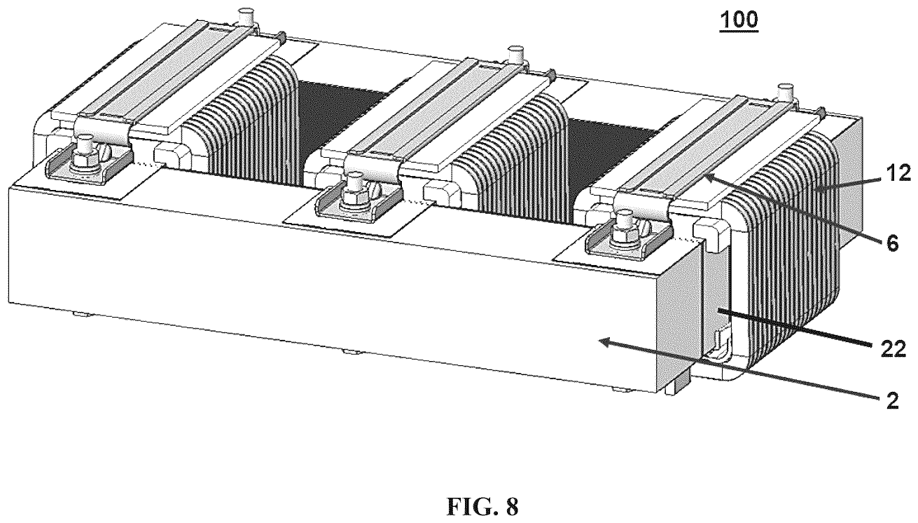

FIG. 8 shows an embodiment of an inductor 100 in a configuration with three leg and coil assemblies 10, wherein each assembly comprises only one coil 1.

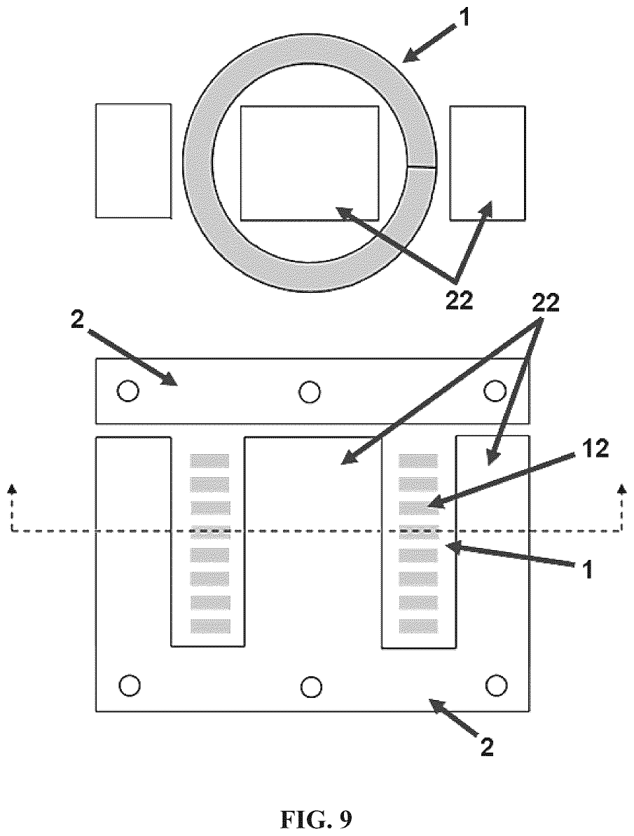

FIG. 9 provides a diagram view of an E+I core with one or more coils 1 on the center leg of E core. This is used for making DC chokes or a single-phase reactor. The air gap is between the three legs and the I leg core 22. Sometimes the air gap is only between center leg of E and the I. Core configurations as in FIG. 1 and FIG. 9, as well as other core configurations, are foreseeable and readily compatible with the flexible design of the present disclosure. For example, another embodiment has a single, solid, integrally built core, or a single core comprising multiple rigidly affixed components supported by a core support 3.

It is noted that many yoke cores use such leg core stacks with a plurality of leg cores 22, as in FIGS. 1 and 8-9, and that these often use a single bolt in a single bolthole in the yoke core 2 to connect the leg core 22 to the yoke core 2 via the core support 3. It is advantageous that several embodiments of the present disclosure are able to implement the present features including the mounting clamp 6 through the same bolt and bolthole attachment method as in the prior art. By implementing the novel support system for the leg and core assembly 10 with identical fixation methods, years of research and understanding of how this bolthole affects conductivity and inductor 100 performance are preserved in embodiments of the novel design.

While the disclosure has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present disclosure covers further embodiments with any combination of features from different embodiments described above and below. Additionally, statements made herein characterizing the disclosure refer to an embodiment of the disclosure and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A preformed, bobbin-less coil assembly device, the coil assembly device comprising:
a core with a first side,
a preformed coil having a plurality of turns, the preformed coil configured to sleeve over the core in an axial direction, having a clearance space between the preformed coil and the core in directions radial to the axial direction, the preformed coil having a first radial side with a radial inner surface and a radial outer surface,
a first insulator positioned in the clearance space and between the radial inner surface of the first radial side of the plurality of preformed coils and the core,
a mounting clamp comprising:
a clamp band,
a clamp spring, and
a first end of the mounting clamp,
wherein the clamp band straddles a portion of the radial outer surface of the first radial side of the preformed coil along the axial direction,
wherein the first end of the mounting clamp is affixed to the core such that the clamp spring is deflected, and
an insulating sheet disposed between the clamp band and the radial outer surface of the first radial side of the preformed coil,
wherein the deflection of the clamp spring by the core urges the clamp band toward the core, and thereby the first radial side of the preformed coil is bracketed to the core.

2. The preformed, bobbin-less coil assembly device of claim 1, wherein a second radial side of the preformed coil is opposite the first radial side of the preformed coil, and the second radial side of the preformed coil is a floating side unbracketed to the core.

3. The preformed, bobbin-less coil assembly device of claim 1, wherein a first core support is arranged between the first side of the core and the first insulator, affixed to the core.

4. The preformed, bobbin-less coil assembly device of claim 2, further comprising a first spring damper positioned in the clearance space and between a radial inner surface of the second radial side of the preformed coil and the core or a second core support along a second side of the core, the second side of the core corresponding to the second radial side of the preformed coil,
wherein the first spring damper is positioned in a locking depression of the core or the second core support, and
wherein the first spring damper is configured to dampen the radial vibrations of the core or the preformed coil which affect the size of the clearance space.

5. The preformed, bobbin-less coil assembly device of claim 1, wherein the first insulator is positioned on a first end of the first radial side of the preformed coil, further comprising:
a second insulator positioned in the clearance space and between a second end of the radial inner surface of the first radial side of the preformed coil and the core.

6. The preformed, bobbin-less coil assembly device of claim 2, further comprising a third radial side and a fourth radial side of the preformed coil, the third radial side and fourth radial side being at 90 degrees to the first radial side as well as floating sides unbracketed to the core.

7. The preformed, bobbin-less coil assembly device of claim 3, wherein the first core support end and the first end of the mounting clamp are affixed to the core at a same position, such that the clamp spring is deflected and the first core support is undeflected or deflected to a lesser or insubstantial degree relative to the deflection of the clamp spring.

8. The preformed, bobbin-less coil assembly device of claim 1, the mounting clamp further comprising:
a clamp rib disposed between the clamp spring and the first end of the mounting clamp and configured to mitigate deflection of the mounting clamp proximate to the clamp rib, and
mounting clamp hems along both of two edges of the clamp band, the edges extending along the clamp band in the axial direction.

9. A preformed, bobbin-less coil assembly device, the coil assembly device comprising:
a yoke core or external support,
a leg core of the yoke core with a first side,
a first core support along the first side of the leg core, affixed to the leg core of the yoke core and the yoke core or external support,
a preformed coil assembly configured to sleeve over the leg core in an axial direction with clearance space in radial directions, the preformed coil assembly including:
a first radial side,
a plurality of nested preformed coils having at least one nested clearance space and an at least one nested insulating sheet on the first radial side between each of the plurality of nested coils,
a radial inner surface of the first radial side of an innermost coil of the preformed coil assembly, and
a radial outer surface of the first radial side of an outermost coil of the preformed coil assembly,
wherein the plurality of preformed coils are concentric to one another,
a first insulator positioned in the clearance space and between the radial inner surface of the first radial side of the preformed coil assembly and the leg core,
a mounting clamp comprising:
a clamp band,
a clamp spring, and
a first end of the mounting clamp,
wherein the clamp band straddles the radial outer surface of the first radial side of the preformed coil assembly along the axial direction,
wherein the first end of the mounting clamp is affixed to the yoke core or external support such that the clamp spring is deflected, and
a first insulating sheet disposed between the clamp band and the radial outer surface of the first side of the preformed coil assembly,
wherein the radial directions are radial to the axial direction,
wherein the deflection of the clamp spring by the yoke core or external support urges the clamp band toward the radial outer surface, whereby the first insulating sheet is compressed and the radial outer surface is urged toward the radial inner surface, whereby each of the plurality of nested preformed coils are compressed upon each of the at least one nested insulating sheets and the radial inner surface is urged toward the leg core of the yoke core, whereby the first insulator is compressed to dampen radial vibrations of the leg core or preformed coil assembly which affect a size of the clearance space, and thereby the first radial side of the preformed coil assembly are bracketed to the core yoke or the external support.

10. The preformed, bobbin-less coil assembly device of claim 9, wherein a second radial side of the preformed coil assembly is opposite the first radial side of the preformed coil assembly, and the second radial side of the preformed coil assembly is a floating side unbracketed to the yoke core or the external support.

11. The preformed, bobbin-less coil assembly device of claim 9, wherein the first core support is disposed between the first insulator and the leg core.

12. The preformed, bobbin-less coil assembly device of claim 10, further comprising a first spring damper positioned in the clearance space and between a second radial inner surface, the second radial inner surface being of the innermost coil of preformed coil assembly and of the second radial side, of the preformed coil assembly and the leg core or a second core support along a second side of the leg core,
wherein the first spring damper is positioned in a locking depression of the leg core or the second core support, and
wherein the first spring damper is configured to dampen the radial vibrations of the leg core or preformed coil assembly which affect the size of the clearance space.

13. The preformed, bobbin-less coil assembly device of claim 9, wherein the first insulator is positioned on a first end of the first radial side of the preformed coil assembly, further comprising:
a second insulator positioned in the clearance space and between a second end of the radial inner surface of the first radial side of the preformed coil assembly and the leg core.

14. The preformed, bobbin-less coil assembly device of claim 10, further comprising a third radial side and a fourth radial side of the preformed coil assembly, the third radial side and fourth radial side being at 90 degrees to the first radial side as well as floating sides unbracketed to the core yoke.

15. A system of preformed, bobbin-less coil assembly devices, comprising:
a yoke core, and
a plurality of preformed, bobbin-less coil assembly devices, each device comprising:
a leg core of the yoke core with a first side,
a first core support along the first side of the leg core, affixed to the leg core of the yoke core and the yoke core,
a preformed coil assembly configured to sleeve over the leg core in an axial direction with clearance space in radial directions, the preformed coil assembly including:
a first radial side,
a plurality of nested preformed coils having at least one nested clearance space and an at least one nested insulating sheet on the first radial side between each of the plurality of nested coils,
a radial inner surface of the first radial side of an innermost coil of the preformed coil assembly, and
a radial outer surface of the first radial side of an outermost coil of the preformed coil assembly,
wherein the plurality of preformed coils are concentric to one another,
a first insulator positioned in the clearance space and between the radial inner surface of the first radial side of the preformed coil assembly and the leg core,
a mounting clamp comprising:
a clamp band,
a clamp spring, and
a first end of the mounting clamp,
wherein the clamp band straddles the radial outer surface of the first radial side of the preformed coil assembly along the axial direction,
wherein the first end of the mounting clamp is affixed to the yoke core or such that the clamp spring is deflected, and
a first insulating sheet disposed between the clamp band and the radial outer surface of the first side of the preformed coil assembly,
wherein the radial directions are radial to the axial direction,
wherein the deflection of the clamp spring by the yoke core urges the clamp band toward the radial outer surface, whereby the first insulating sheet is compressed and the radial outer surface is urged toward the radial inner surface, whereby each of the plurality of nested preformed coils are compressed upon each of the at least one nested insulating sheets and the radial inner surface is urged toward the leg core of the yoke core, whereby the first insulator is compressed to dampen radial vibrations of the leg core or preformed coil assembly which affect a size of the clearance space, and thereby the first radial side of the preformed coil assembly are bracketed to the core yoke.

16. The system of preformed, bobbin-less coil assembly devices of claim 15, wherein a second radial side of the preformed coil assembly is opposite the first radial side of the preformed coil assembly, and the second radial side of the preformed coil assembly is a floating side unbracketed to the yoke core.

17. The system of preformed, bobbin-less coil assembly devices of claim 15, wherein the first core support is disposed between the first insulator and the leg core.

18. The system of preformed, bobbin-less coil assembly devices of claim 16, further comprising a first spring damper positioned in the clearance space and between a radial inner surface of the second radial side of the preformed coil assembly and the leg core or a second core support along a second side of the leg core,
wherein the first spring damper is positioned in a locking depression of the leg core or the second core support, and
wherein the first spring damper is configured to dampen the radial vibrations of the leg core or preformed coil assembly which affect the size of the clearance space.

19. The system of preformed, bobbin-less coil assembly devices of claim 15, wherein the first insulator is positioned on a first end of the first radial side of the preformed coil assembly, further comprising:
a second insulator positioned in the clearance space and between a second end of the radial inner surface of the first radial side of the preformed coil assembly and the leg core.

20. The system of preformed, bobbin-less coil assembly devices of claim 16, further comprising a third radial side and a fourth radial side of the preformed coil assembly, the third radial side and fourth radial side being at 90 degrees to the first radial side as well as floating sides unbracketed to the core yoke.
